(19) United States
(12) Patent Application Publication
(10) Pub. No.: US 2006/0125923 A1
(43) Pub. Date: Jun. 15, 2006

(54) LCD photographic printer

(76) Inventors: Richard Israel, Cleveland, TN (US); Ronald Redmer, Lake Orion, MI (US)

Correspondence Address: Rubinstein Law Group, Professional Corporation;David Bogart Dort, 1700 Diagonal Road, Suite 300, Alexandria, VA, 22314, US

(21) Appl. No.: 11/009,523

(22) Filed: Dec. 11, 2004

(51) Int. Cl. H04N 5/225

(52) U.S. Cl. 348/207.99

(57) ABSTRACT

A high-speed photographic printer having an imaging active matrix liquid crystal display with a corrective lens arrangement confronting the imaging active matrix liquid crystal display. The high-speed photographic printer includes a light sealable housing, a lens drawer located between the imaging active matrix liquid crystal display, an operating system that perceives RAM as a hard drive, and a light stream having an orange hue that is conventionally provided by a film negative. Image information is provided to the imaging active matrix liquid crystal display. Customer information associated with the image information is imprinted on the photosensitive material adjacent to the image with an optical marker in the light sealable housing. Such imprinted information is sensed down line from the high-speed photographic printer such as at a cutting station.

### FIELD OF THE INVENTION

The present invention relates generally to a photographic printer apparatus and method more specifically to a photographic printer apparatus and method using a liquid crystal display array to form the image exposed to the photosensitive paper.

### BACKGROUND OF THE INVENTION

The art of photography and the use of a digital camera cannot be linked. Photographic masters do not necessarily take better or worse photos with a digital camera. Professional photographers, such as wedding photographers, may doctor their shots with digital processing, but the essence of the wedding is still captured by the person behind the camera. The inexpensive digital camera cannot generally capture the snapshot any better than the predecessor box camera.

Likewise, the art of printing onto photosensitive paper remains an art, whether the photographic printer includes a film negative, CRT, or LCD parcel as the medium for forming the image exposed to the photosensitive paper. In his or her unique area of photographic technology, the manufacturer of the photographic printer must produce a machine that in turn produces a professional quality photograph among thousands of other photographs that has perfect colors and is customized if desired.

### SUMMARY OF THE INVENTION

The present invention implements a high-speed photographic printer where the LCD chip forms the images exposed to the photosensitive paper.

Another feature of the present invention is that in a high-speed photographic printer, the LCD chip can form the images exposed to the photosensitive paper high-speed and the corrective lens arrangement makes the LCD generated image symmetrical and centric.

Another feature of the present invention is provided in that in a high-speed photographic printer, the LCD chip forms the images exposed to the photosensitive paper high-speed and a lens cluster between the LCD chip and photosensitive paper, provides for optically separating the image emanating from the LCD chip into two or more images that are exposed to the photosensitive paper.

Another feature of the present invention includes the situation where the LCD chip forms the images exposed to the photosensitive paper high-speed and a lens cluster is disposed between the LCD chip and photosensitive paper. Thus, the option is provided for selecting one or more lenses on demand for enlarging the LCD generated image to a particular ultimate size on the photosensitive paper.

Another feature of the present invention in which the the LCD chip forms the images exposed to the photosensitive paper; a high-speed a “ramdisk,” where the “ram disk” is perceived as a hard drive by the operating system but in actuality is RAM, a “random access memory” large capacity solid state device. Information can be downloaded to the LCD chip without a fragmentation in a minimum amount of time.

Another feature of the present invention takes advantage of a based optical marker, marks information that is machine or human readable at a cutting station down line from the high-speed photographic printer. Another feature of the present invention includes having a pair of markers mark information on the photosensitive paper. One marker encodes on the photosensitive or front side and the other marker encodes on the back side.

Another feature of an embodiment is structured such that the LCD chip is actuated horizontally and vertically to compensate for pixel-dead space and a lens is actuated at the same time and same direction as the LCD chip.

Another feature of the present invention can be the creation of a particular orange hue of the light impinges upon the LCD chip such that conventional photosensitive paper responds to such light in the same or similar manner that the conventional photosensitive paper responds to a conventional film negative with an orange hue.

Additional optional features include structures where there is a relatively high powered light source and from first and second diffusers between the high power light source. The LCD chip maximizes the power of the light that can be used and maximizes the dispersion of the high power light.

In this embodiment, a mixing chamber between the high power light source and the LCD chip can be used. A cold mirror that disposes between the high power light source and the mixing chamber minimizes the entry of infrared light and maximizes the entry of visible light into the mixing chamber. Minimizing the need for filters in the mixing chamber, thereby increases the amount of light available to the LCD chip.

Other implementations include where is a dual back writer where the dual back writer is a dual impact dot-matrix writer such that a relatively great amount of information can be placed on the back of photosensitive material.

An optical marker can be added to a particular end that provides for writing information on the front of the photosensitive material without the need for rendering it into the image exposed on the LCD array minimizing the image area on the LCD array.

Other option features may include a lamphouse with a 1000 watt bulb minimizes exposure times and maximizes a “throughput” or amount of light passing ultimately to the photosensitive material, and further has solenoid actuation of color filters in the lamphouse to maximize production time.

The high-speed air operated iris shutter provides for one group or cluster of lenses. The present invention includes the step of covering portions of the photosensitive material in a light sealable cabinet instead of reducing the size of the image in the LCD chip such that the size of the image in the LCD chip is maximized and the paper space is saved for multiple size prints where such covering of the unused areas is performed by a paper stepper mask. A package punch punches binary codes into the photosensitive material for automatic package cutting machines. A lens drawer provides for high-speed changing of lenses for production of multiple sizes (instead of using a single lens to produce a single size print) such that high-speed photographic paper produces multiple sizes without being reconfigured.

An advantage of the present invention is that the best of both worlds is provided for with a high-speed photographic printer. Images can be produced electronically at high resolution via the LCD array and at the same time an on-demand high technology optic lens system that can manipulate the high resolution LCD generated image into any one of a number of packages, without loss of resolution.

Additionally, the packages may have images of the same or different size. The orientation of the images may be the same or different, and/or the number of images may be the same or different. Another advantage is that the present LCD photographic printer provides for high volume printing. The LCD photographic printer is a high-speed, photographic printer that can expose from 500 to 1000 or more unique eight inch by ten inch images onto photosensitive material per hour.

Other advantages of various embodiments include: Another advantage is that the present LCD photographic printer produces multiple images in one of two ways. Such multiple imaging may originate at the LCD chip or originate at the lens cluster.

Another advantage is that the present LCD photographic printer can operate either as a stand-alone printer or fully networked with the (Gigabit) Ethernet networking standards. Another advantage is that the present LCD photographic printer can, with white space, in fill or package mode, produce prints from sub-wallet size to eleven by fourteen inches.

The present LCD photographic printer is simple and inexpensive to manufacture, operate, maintain and repair. The LCD array of the present LCD photographic printer can be readily tied into other digital aspects of high-speed photographic printers, such as independent microprocessors at the markers and stepper motor paper advance mechanisms.

High-speed photographic printer interfaces with off-the shelf popular third party imaging software and professional lab software. The correcting lens arrangement straightens the light path of the image picked up at the LCD chip to provide 2.5 more f/stops for faster exposures.

The printing process can be stopped and started easily such that rush orders or customized orders can be printed in an intermittent manner. The printer can be upgraded with either a higher LCD chip, a new CPU, a new lens drawer, a new lamphouse or some other easily replaceable or upgradeable portion.

### IN THE DRAWINGS

FIG. 1 is a diagrammatic view of a photographic printer apparatus of the present invention that has printing, processing, inspection, cutting and packaging stations;

FIG. 2 is a front plan view of the photographic printer of the apparatus of FIG. 1;

FIG. 3 is a rear plan view of the photographic printer of FIG. 2;

FIG. 4 is a side view of the photographic printer of FIG. 2 and shows an opened control panel of the photographic printer;

FIG. 5 is a detail view of a portion of the photographic printer of FIG. 2, showing an LCD device with a correction lens arrangement and a rotary table for the LCD device with the correction lens arrangement;

FIG. 6 is a diagrammatic view of the LCD device of FIG. 5 with the correction lens arrangement, of a lens cluster of the photographic printer of FIG. 2, and of the cabinet housing the photosensitive paper onto which is shot the optical image of the LCD array;

FIGS. 7A and 7B show a block diagram of the control aspects of the photographic printer;

FIG. 8A shows an optical image formed by the LCD array of FIG. 6;

FIG. 8B shows a set of optical images formed by the LCD array of FIG. 6;

FIG. 9 shows a diagrammatic view of the LCD device of FIG. 6 with the correction lens arrangement which is used in combination with one type of lens cluster;

FIG. 10 shows a diagrammatic view of the LCD device of FIG. 6 with the correction lens arrangement and used in combination with another type of lens cluster.

FIGS. 11A, 11B, and 11C set out a flow chart for the method of the present invention using the photographic printer of FIG. 2 and the LCD device of FIG. 6 with the correction lens arrangement;

FIG. 12 is a diagrammatic view of a portion of the method charted in FIG. 11C and shows this in an exaggerated form: one unit has the LCD array and correction lens arrangement which are moved horizontally and vertically to compensate for dead space in the pixels of the LCD array. In other words, the physical image is micro-shifted a sufficient distance to paint dead space, such as by a piezoelectric solenoid. This distance may be the distance of one pixel;

FIG. 13 is a diagrammatic view of the LCD device of FIG. 5 (with the correction lens arrangement of a lens cluster of the photographic printer of FIG. 2) and has a cabinet which houses the photosensitive paper onto which is shot the optical image of the LCD array where the correction lens arrangement has a single lens;

FIG. 14 is a diagrammatic view of the LCD device of FIG. 5: the correction lens arrangement has a lens cluster of the photographic printer of FIG. 2 and further shows diagrammatically dialed-in color filters, fixed color filters. The lens arrangement has an orange transparent sheet for lending all orange hue to light that impinges upon and passes through the LCD array and ultimately exposes the photosensitive paper.

### DESCRIPTION OF THE PREFERRED EMBODIMENT

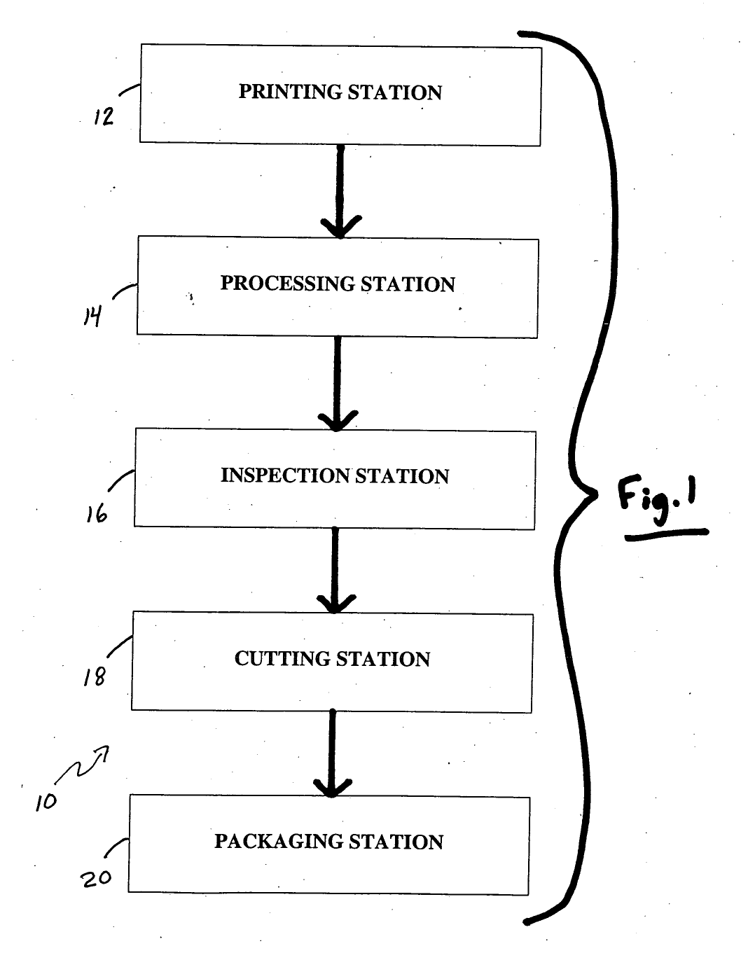

As shown in FIG. 1, the photographic printer apparatus 10 of the present invention includes a turn-key system having at least a printing station 12, a processing station 14, an inspection station 16, a cutting station 18 and a packaging station 20.

As shown in FIG. 1, the printing station 12 includes a photographic printer 22. The photographic printer 22 generally includes: a frame 24, lamphouse 26, an LCD device 28 with a correcting lens arrangement, a lens array 30 that has one or more enlarging leas, a light sealed cabinet 32, a processor 34 that may be connected to a network, a monitor 36, and a control panel 38. The lamphouse 26 provides a source of light that is directed through the LCD device 28 and its correcting lens and also through the lens array or cluster 30. It is then directed into the darkroom portion 32 where photosensitive paper is exposed and where the image of the LCD device 28 is captured. The processor 34 may be a Pentiums® 4 2.50 Ghz/100/512/Radeon 9500DVI video PC.

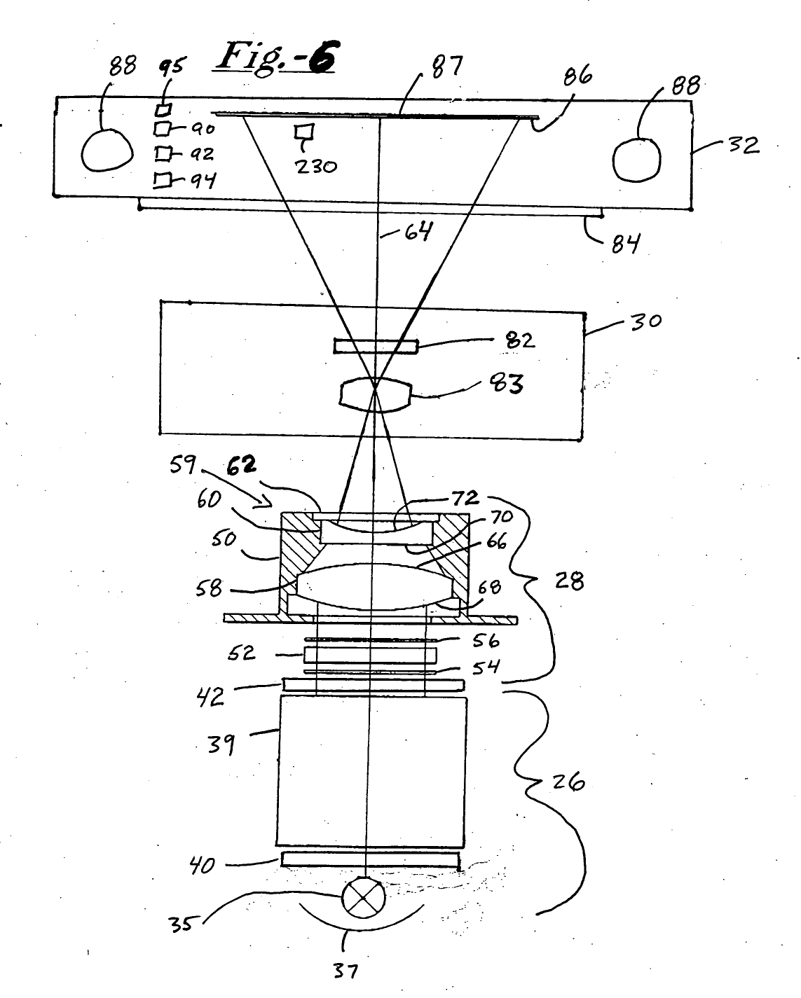

The lamphouse 26 and LCD device 28 as shown in FIG. 6, includes a halogen light source 35, a reflector or cold mirror 37, and a mirrored mixing chamber 39. The light source or bulb 35 is preferably of high power, generally in the range of about 500 to about 2000 watts or about 1000 in a preferred embodiment.

The lamphouse 26 further includes a first diffuser 40, disposed between the mixing chamber 39 and bulb 35 for diffusing light prior to the light entering the mixing chamber 39. The lamphouse 26 further includes a second diffuser 42, disposed between the LCD device 28 and the mixing charmer 39 for diffusing light after the light exits the mixing chamber 39 prior to the light entering the LCD device 28. The first diffuser 40 is formed of a material highly resistant to heat generated by a bulb of 1000 watts or more and is preferably formed of glass that is translucent. The second diffuser 42 is formed of a translucent plastic. Each of the first and second diffuser 40 and 42 may be about 1/16 of an inch to about 1/18 of an inch thick.

Further, lamphouse 26 includes a translator that monitors light in the mixing chamber 39 and provides a digital display of color values. Lamphouse 26 may provide readings in one cc increments for simple and precise diachronic color adjustments. Such digital translator in the lamphouse samples light in the mixing chamber 39 and displays the cc values of each color. A solid state regulator in the lamphouse keeps voltage within a one-half of one percent such that a steady light output is maintained. In the case of excessive heat, the lamphouse will automatically shut off.

The light source or bulb 35 directs light toward the cold mirror 37, which then directs the visible portion of the spectrum back toward the diffuser 40 and into the mixing chamber 39 and beyond. The cold mirror 37 separates the 30 infrared light (heat source) from the visible portion of the spectrum such as by permitting the infrared light to pass through or by scattering or absorbing the heat. The use of a cold mirror 37 maximizes the speed of the photo printing process and minimizes reliance on color filters in the mining chamber 39. Color filters reduce the amount of available light and increase the amount of time required for exposure. The cold mirror 37 hence reduces the amount of time required for exposure.

As to mixing chamber 39, the U.S. Pat. No. 5,097,289 issued Mar. 17, 1992 and entitled “Photographic Printer” to Lucht for the purpose of teaching the characteristics of this feature, can be used in a preferred embodiment and is hereby incorporated by reference. The two diffusers 40 and 42, with the use of a bulb of 1400 watts or more, minimize the chances that hot spots will form on the LCD generated image. The reflector 37 reflects back as much as possible the full force of the 1000 watts generated by bulb 35. By maximizing the amount of light reflected back into the mixing chamber 39, the exposure time may be minimized and the rate of the photographic printing process is consequently maximized.

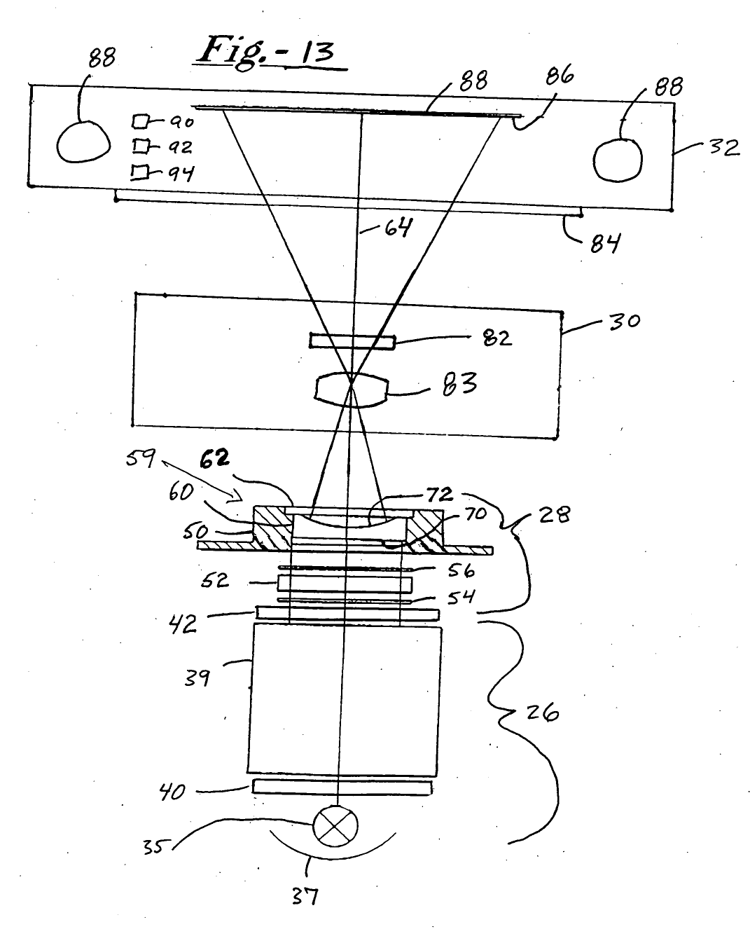

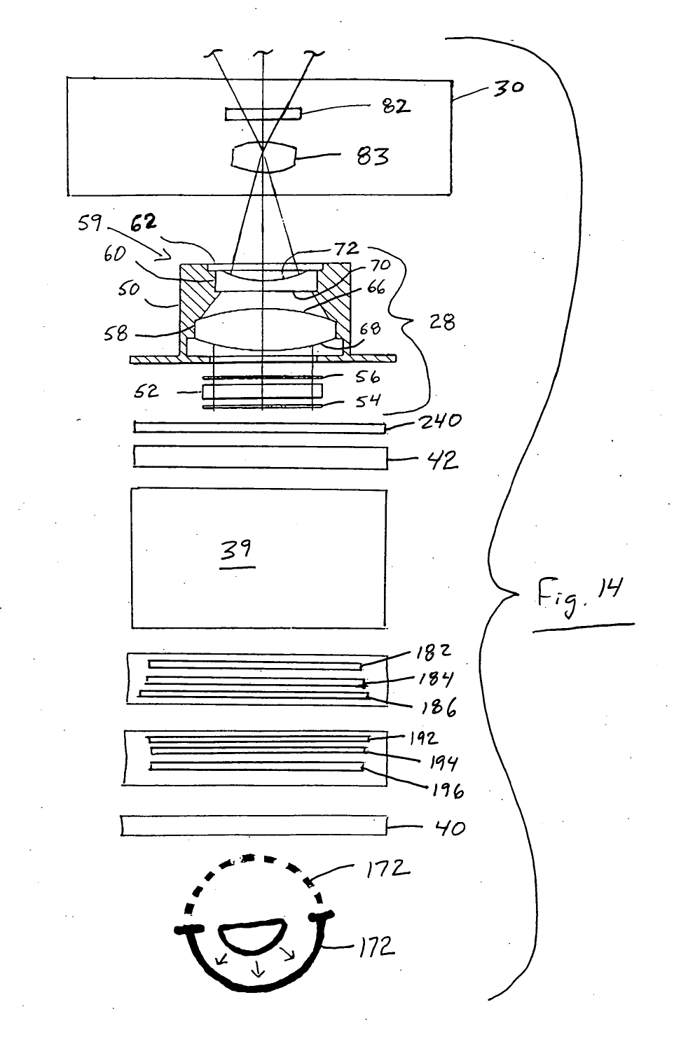

The LCD device 28 includes a housing 50 having engaged thereto a liquid crystal display chip or an array 52 which is sandwiched between a pair of polarizing filters or plates 54 and 56. The polarizing filters or plates may be separated from the LCD chip 52 or integrated into the LCD chip 52. Further included in the housing 50, is a convex lens 58, a diffusing or dispersing lens 60 and an element 62 which may be a diopter or a retaining ring. Photographic printing station 22 further includes an optical axis 64, shown in FIG. 6. It should be noted that housing 50 may not be rigidly engaged in the LCD device 28, but instead may slide slightly or be actuated by vertical and horizontal relays 188 and 190, slightly relative to the LCD device 28, as shown in FIG. 12. The correcting lens arrangement 59, it should be noted, provides no reduction in the amount of light and should be an inexpensive device for making light waves emanating from the LVD chip 52 symmetrical, even and centric. Convex lens 58 includes opposing convex surfaces 66 and 68. Diffusing lens 60 includes a flat surface 70 and 5 a concave surface 72 that oppose each other, shown in FIG. 6. In a preferred embodiment, as shown in FIG. 13, only a diffusing lens 60 is utilized, along with a diopter or retainer 62, if desired.

1) lens 58 and/or lens 60 2) the shapes of the surfaces of lens 58 and, 60, 3) the slopes of the surfaces of leas 58 and 60 4) the relative and absolute distances among the LCD chip, lens 58 and lens 60 are five factors that work together to manipulate light exiting the LCD chip 52. This manipulation may control the following: a) the focus of the image; b) the size of the image; c) the symmetry and centricity of light waves. Preferably, lens 58 or 60 is as close as possible to the LCD chip 52 without damaging the integrity of the LCD chip 52 or the polarizing plate 56 on the LCD chip 52. The distance between the apex or point of the bottom surface 68 of convex lens 5B (or the bottom flat surface 70 of lens 60) and an uppermost portion of the LCD chip or polarizing plate 56 is preferably between about 0.01 millimeters and 2 centimeters, most preferably between about 0.01 millimeters and 1 millimeter maximizing the symmetry of the image and the centricity of the image. It should be noted that, preferably, the LCD chip 52 has an upper protective plate or resin and that this protective plate or resin may be a polarizing plate or filter. In the case where the polarizing plate 56 is separate from the LCD chip 52, then it is preferred that the lower surface of the polarizing plate 56 is as close as possible to the uppermost portion of the LCD chip 52 (preferably within the ranges noted above). In turn, the lowermost point or apex of lens surface 68 (or flat surface 70 of lens 60) is as close as possible to the upper surface of the polarizing filter 56 (preferably within the ranges noted above).

The convex lens 58 and diffusing lens 60, whether used in combination or alone, may be referred to as a corrective lens arrangement 59. The corrective lens arrangement ensures that the light waves exiting the LCD chip 52 are symmetrical and centric relative to optical axis 64 and one or more lenses is in lens cluster 30. Preferably, lens 58, lens 60, diopter or retainer 62, and the one or more lenses in lens cluster 30, and iris shutter 82 are aligned with the optical axis 64 within a range between about 0 macrons and about 1000 microns, and about 500 microns in a preferred embodiment.

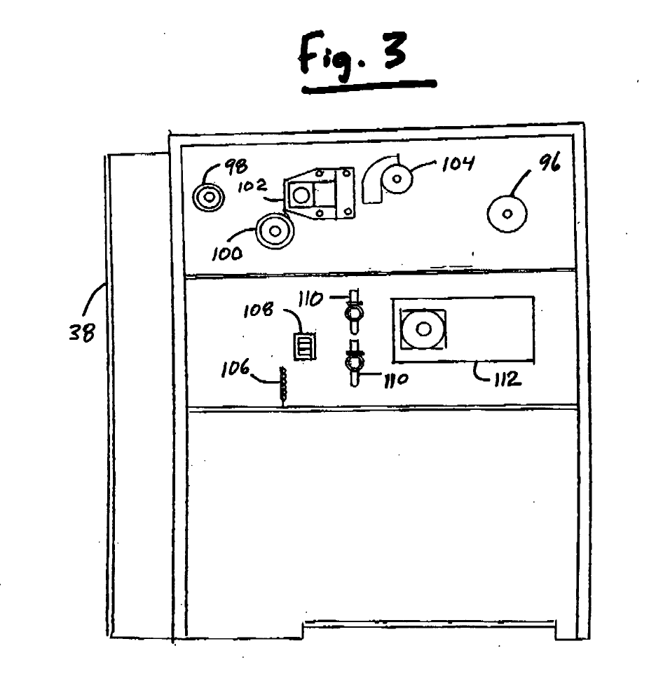

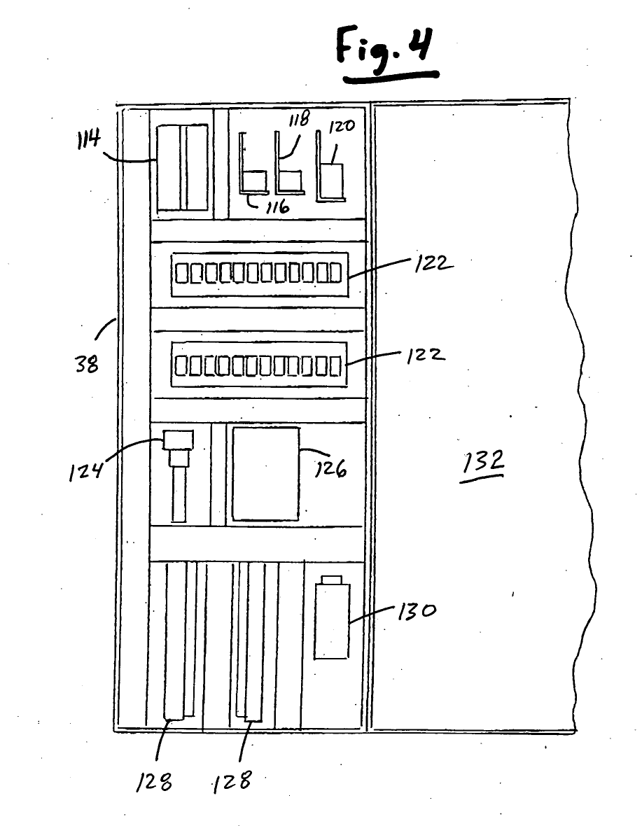

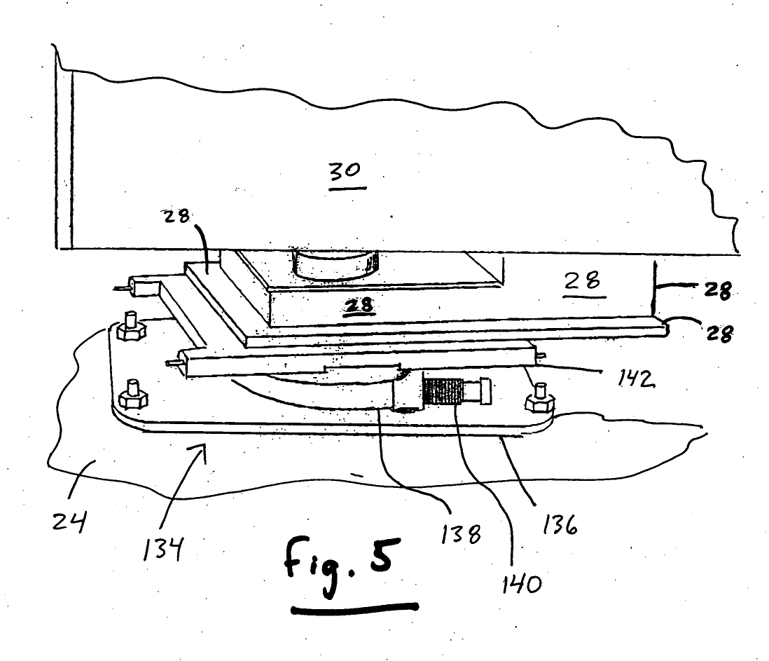

A control box 112 for the LCD device 52 is mounted on the frame 24 of the printer 22 and is shown in FIG. 3. As to the LCD array 52, the following U.S. patents are hereby incorporated by reference: 1) the DeClerck et al. U.S. Pat. No. 6,437,849 issued Aug. 20, 2002 and entitled, “Method and Apparatus For Printing on A Photosensitive Material Using A Liquid Crystal Display”; 2) the DeClerck et al, U.S. Pat. No. 5,870,205 issued Feb. 9, 1999 and entitled, “Method and Apparatus For Correcting Light Non-Uniformity In An LCD Photographic Printer”; 3) the DeClerck at al. U.S. Pat. No. 6,130,740 issued Oct. 10, 2000 and entitled. “Method and Apparatus for Printing on a Photosensitive Material Using a Liquid Crystal Display.”

Further as to the LCD array 52 and to the extent permitted, European Patent, Application EP 1 118 894 A2 published Jul. 25, 2001 and invented by Helmut Gehner (Goehner) and entitled, “Vorrichtung zum Vergrossern and Belichten von digitalen Belichtungsdaten auf lichtempfindliches Fotopapier,” is hereby incorporated by reference.

The LCD chip 52 may be defined as an imaging active matrix liquid crystal display for producing a n image through which light passes for printing the image onto photosensitive material. The LCD chip 52 may be a Sony 8, 10, 12 or 16 megapixel array, available from Sony Corporation of Tokyo, Japan. The LCD chip 52 has a resolution of 3200 pixels by 2400 pixels. The ultimate print resolution on the photosensitive material is 320 dpi for an eight inch by ten inch image and 250 dpi for an eleven inch by fourteen inch image. The LCD subsystem may be one or more of the sets of instructions 220, 222 that controls calibration, color profile and rendering to the LCD chip 52. It also may control physical exposure and image shifting, lamphouse control and diagnostics.

The mirrored feature of the mixing chamber 39 provides for an increased amount of light ultimately transmitted to the photosensitive paper. This increase in the amount of light allows for stepping down high magnification lenses 83 for a greater depth of field, thereby resulting in better focus. The lens cluster 30 is an array of one or more lenses 83 for enlarging or manipulating the image forwarded by the corrective lens arrangement having lens 58 and 60. As to the lens cluster 30, the following U.S. patents are hereby incorporated by reference: 1) the Lucht U.S. Pat. No. 3,951,545 issued Apr. 20, 1976 and entitled, “Photographic Print Apparatus”; 2) the Lucht et al. U.S. Pat. No. 4,583,845 issued Apr. 22, 1986 and entitled, “Photographic Printer”; 3) the Lucht et al. U.S. Pat. No. 5,097,289 issued Mar. 17, 1992 and entitled Photographic Printer, and 4) the Lucht et al. U.S. Pat. No. 5,045,877 issued Sep. 3, 1991 and entitled Photographic Printer.

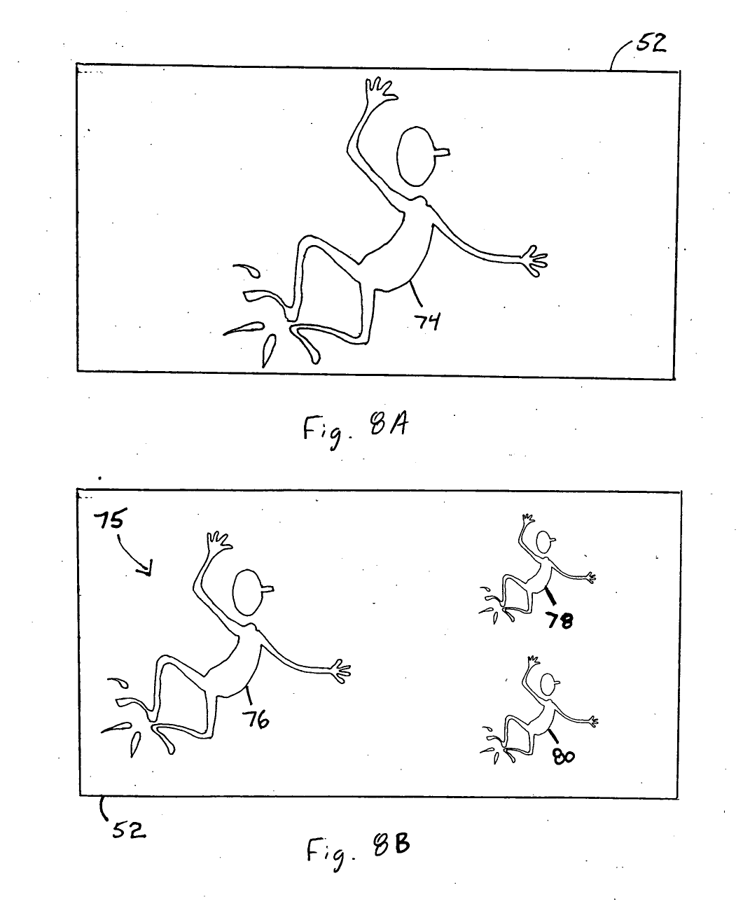

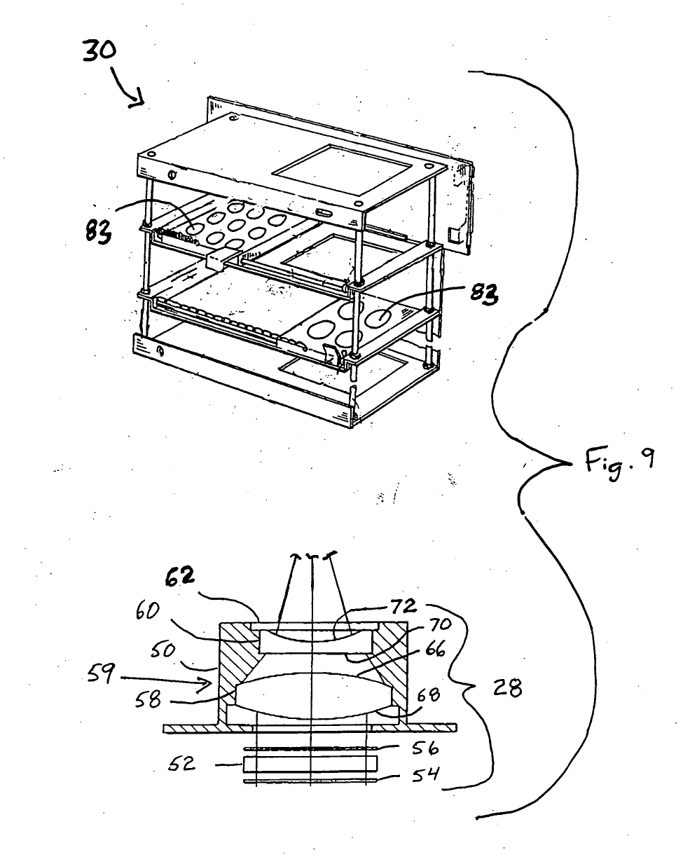

The provision of the combination of an LCD chip 52 and a lens cluster 30 provides for a great number of ways for manipulating the image ultimately exposed to the photosensitive paper. For example, FIG. 8A shows a single image 74 generated by the LCD chip 52. This single image 74 may be shot with one exposure through a single lens of lens cluster 30 such that image 74 is reproduced as is on photosensitive paper in the light sealed cabinet 32. Additionally, this single image 74 may be shot with one exposure through a set of two or more lenses of lens cluster 30 such that image 74 is reproduced two or more times on the photosensitive paper in light sealed cabinet 32. Such steps are preferred and offer the best of both electronics and optics: a high resolution LCD array 52 to which information may be loaded quickly from a “ramdisk” and onto which the image 74 is displayed to a maximum size; and a high-speed photographic printer 22, including lens cluster 30 through which image 74 is shot and manipulated.

In another example, FIG. 8B shows set 75 of images 76, 78 and 80, where the images happen to be identical and where image 76 is greater in size than images 78 and 80, which in turn are identical in size. This image set 75 may be shot with one exposure through a single lens of lens cluster 30 such that image set 75 is reproduced as is on photosensitive paper in light sealed cabinet 32. Another option is this image set 75 may be shot with one exposure through two or more lenses of lens cluster 30 such that image set 75 is reproduced two or more times on the photosensitive paper in light sealed cabinet 32. Yet another option is that one of the images, such as image 80, may be selected. This image 80, which may be the same or different from images 76 and 78, may be shot with one exposure through a single lens of lens duster 30 such that image 80 is reproduced on photosensitive paper in the light sealed cabinet 32. Lastly, image 80 may be shot with one exposure through two or more lenses of lens cluster 30 such that image 80 is reproduced two or more times on the photosensitive paper in light sealed cabinet 32.

Processing time with LCD arrays, such as LCD chips 52, is relatively slow when compared to the rate of speed photosensitive paper, to the rate of speed of advancing a lens into and out of the lens cluster 30, and to other mechanical or hydraulic operations of the photographic printer 22. Such processing time has been greatly expedited with the use of the present “ramdisk.”

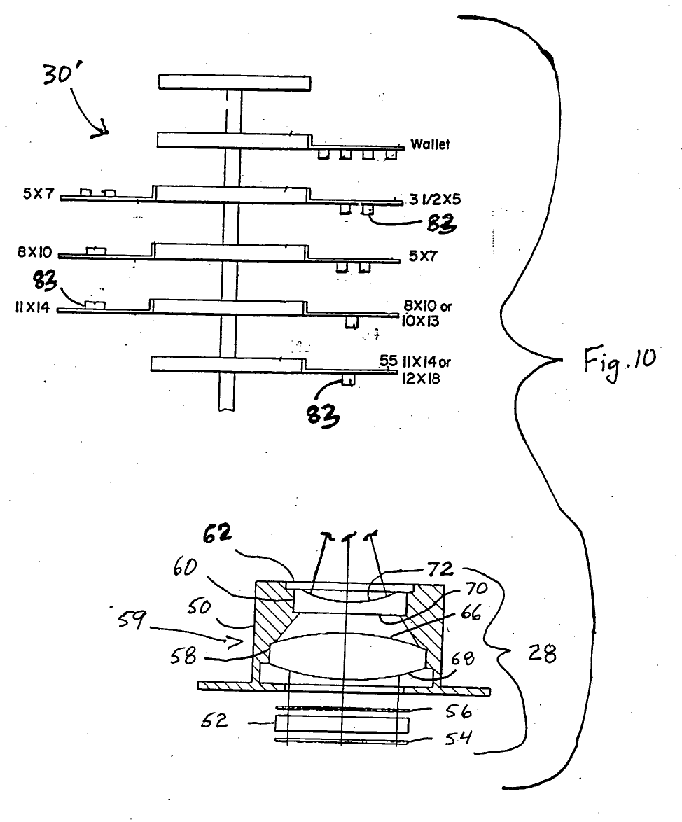

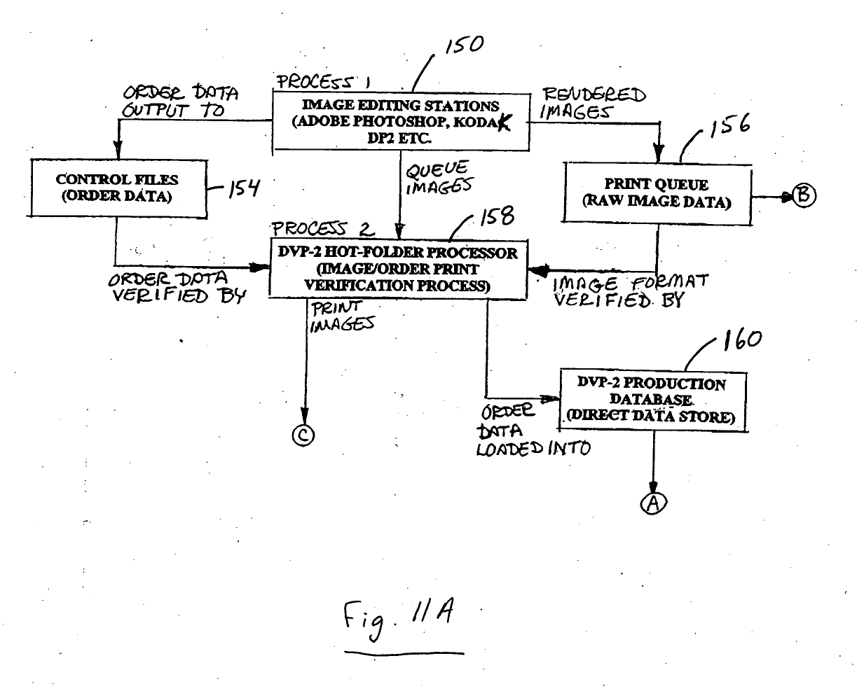

Operations may be preferably combined with other operations. For example, some images will be broken down into sets solely by the LCD array 52 and shot through a single lens of lens cluster 30. In this case, some images will be formed as a single image on the LCD array 52 and then broken down into a set of images through two or more lenses of lens cluster 30 (this is the preferred operation). Some images will be formed as a single image of the LCD array 52 and then not broken down into a set of images through two or more lenses of lens duster 30 but instead be exposed through only one lens of lens cluster 30 (which operation is also a preferred operation), and where some images will be broken down into sets by the LCD array 52 and then further broken down by two or more lenses of lens cluster 30. The selection of which of the above noted operations to employ may depend upon certain factors, such as the resolution of the LCD chip 52. As to lens cluster 30 shown in FIG. 9, the Lucht U.S. Pat. No. 3,951,545 issued Apr. 20, 1976 and entitled Photographic Print Apparatus is hereby incorporated, by reference in its entirety. As to lens cluster 30′ shown in FIG. 10, the following U.S. patents are hereby incorporated by reference: 1) the Lucht et al. U.S. Pat. No. 5,097,289 issued Mar. 17, 1992 and entitled Photographic Printer, and 2) the Lucht et al. U.S. Pat. No. 5,045,877 issued Sep. 3, 1991 and entitled Photographic Printer.

The lens cluster 30 includes an iris shutter 82 disposed between a lens of the lens cluster 30 and the 15 photosensitive paper, as shown in FIG. 6. The iris shutter 82 is centered on the optical axis 64. Just like a lens or a set of lens is engaged in a lens drawer that may be actuated into and out of position, the iris shutter 82 too is engaged in a drawer that may be shuttled into and out of position with axis 54.

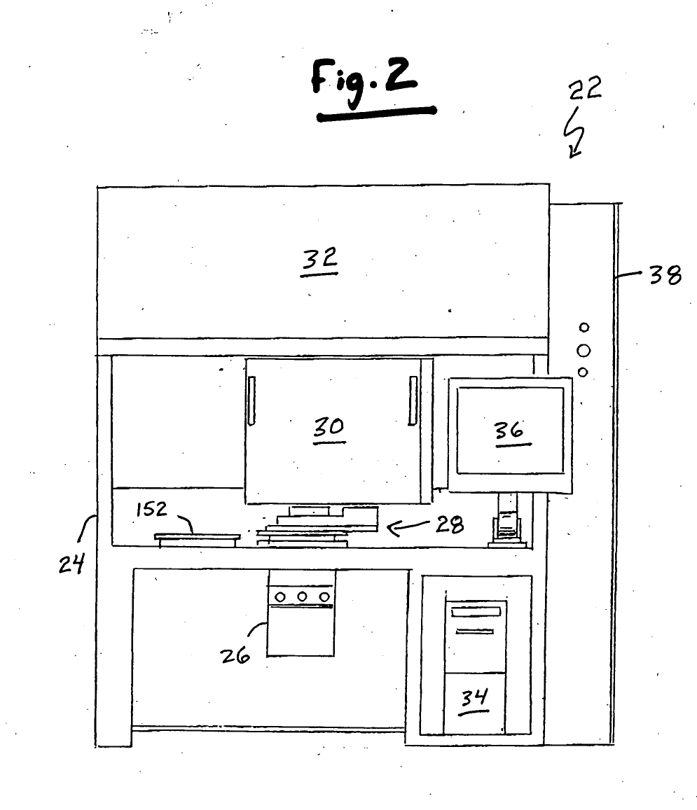

The lens cluster 30 may be removed from the frame of the printer 22 and another lens cluster 30 may be inserted. Mechanisms, such as air regulated plungers, remain engaged with the frame and portions of these mechanisms are shown in FIG. 3. For example, FIG. 2 shows wire terminals 106, valves 10, and air regulators 110. The interchangeable lens drawer or cluster 30 provides for refocusing and alignment. One lens drawer may be slid out and another lens drawer slid, in. Such an operation may be performed under regular room or ambient light conditions.

The lens cluster or drawer 30 includes handles on its front side such that the drawer 30 can be slid into and out of the high-speed photographic printer 22 such that the drawer 30 can be lifted up to the height slightly below the light sealed cabinet 32. It should be noted that sub-drawers (sliding receptacles) having lenses mounted on them are disposed within the lens cluster or drawer 30.

Lens 83 is not necessarily an enlarging lens and may have different optics that could reduce the size of the image, for example. Each of the lenses of the lens cluster 30 provides corner to corner sharpness. A lens slides or travels a minimal distance into (or out of) the optical axis 64 so as to maximize production time, with the minimal distance being preferably less than three inches. Most preferably, the distance is about two inches. Within these parameters, the lower range of the distance traveled is sufficient to remove the lens or its retainer or housing out of the optical axis.

The light sealed cabinet 32 includes the following: a pan shutter 84; photosensitive paper 86; platen 87 for engaging the photosensitive paper 86; a photosensitive paper control mechanism 88 having feed and take-up reels; and lastly, markers 25 90, 92, 94, and 95 for marking the photosensitive paper 86 with information. The paper control mechanism 88 is preferably a digital motion controller with a high-speed paper advance mechanism. As to the light sealed cabinet 32, the following four U.S. patents are hereby incorporated by reference in their entireties: 1) the Lucht U.S. Pat. No. 3,951,545 issued Apr. 20, 1976 and entitled Photographic Print Apparatus; 2) the Lucht et al. U.S. Pat. No. 4,583,845 issued Apr. 22, 1986 and entitled Photographic Printer; 3) the Lucht et al. U.S. Pat. No. 5,097,289 issued Mar. 17, 1992 and entitled Photographic Printer; 4) the Lucht et al. U.S. Pat. No. 5,045,877 issued Sep. 3, 1991 and entitled Photographic Printer.

As shown in FIG. 3, the light sealed cabinet 32 includes a photosensitive paper supply roller 96, a photosensitive paper take up roller 98, a drive platen roller 100, a paper drive motor assembly 102, and a paper supply dancer arm 104. As to the vacuum platen 87 and drive platen roller 10 100, the Lucht et al. U.S. Pat. No. 5,099,277 issued Mar. 24, 1992 and entitled, “Vacuum Platen For Use In A Printer” is hereby incorporated by reference in its entirety.

It should be noted that a pan shutter 84 may include a leading portion and a trailing portion. A slot may be formed between the leading and trailing portions and this slot “moves” as the leading portion. The trailing portion slides back and forth to permit the entry of light into the light sealed cabinet 32. The lens cluster 30 is engaged relatively close to the light sealed cabinet 32 such that when the pan shutter 84 is open, relatively little light leaks into the light sealed cabinet 32. The control panel 38 includes: breakers (fuses) 114; a five volt power supply 116; a 12 volt power supply 118; a 24 volt power supply 120; optically isolated solid state relays 122; A/C contactors 124; a USB-RS232 8-port converter 126; terminal strips 128, and a servo motor 30 controller 130 for the photosensitive paper feed and take-up mechanism. Control panel 38 further includes a door 132.

A rotary table mechanism 134 is disposed between a 35 desk top of frame 24 and the lens cluster 30 for mounting and rotating the LCD device 28. The rotary table mechanism 134 includes a mounting plate 136 bolted to the desk top of frame 24, a stop mechanism 138, having adjustable stops 140, and a rotating table 142, pivotally mounted on the stop mechanism 138 and engaging the LCD device 28. The rotating table 142 is actuated by air cylinders. A ninety degree rotation is preferred. As to the rotary table mechanism 134, the Lucht U.S. Pat. No. 3,951,545 issued Apr. 20, 1976 and entitled, “Photographic Print Apparatus,” is hereby incorporated by reference.

The LCD chip 52 has a fixed resolution. Accordingly, a larger image such as image 74 is more sharp or crisp after being exposed and developed on the photosensitive paper than is a smaller image such as image 76 or images 78 and 80, shown in FIGS. 8A and 8B. When exposed and developed on photosensitive paper, images 78 and 80 are less sharp than image 76, which in turn is less sharp than image 74. By rotating the image formed on the LCD chip 52, use of photosensitive paper is maximized. In other words, a relatively large image on the LCD chip provides a relatively great sharpness when exposed to photosensitive paper. However, the space available on the photosensitive paper may change according to the immediately previous exposure or to the size of the photosensitive paper being used or to other factors. Opportunities to use the largest possible image on the LCD chip 52 are maximized because of the capability to rotate the LCD device 28 and therefore the image on the LCD array 52 which make best use of the available space on the photosensitive paper with a minimum of waste of the paper.

The LCD device 28 is sealed to keep dust and dint out and includes a glass bottom or a glass bottom portion. A focal plane is provided by one or more of the corrective lenses of the corrective lens arrangement 59 and, accordingly, there is no dust or dirt at this digital focal plane that is now in effect housed in a lens.

The photosensitive paper 86 is marked in the light sealed cabinet 32 to provide information to the apparatus in subsequent stations, such as the processing station 14, the inspection station 16, the cutting station 18, and the packaging station 20. Such marking may be on either of the sides of the photosensitive paper and/or a type of marking where the mark is one or more punches through the photosensitive paper. The photosensitive material may be marked with a single punch, a package punch, a marker bar, or an optical (laser based) LED encoder.

As to providing punch markings to the photosensitive paper, the Rasmussen, Jr. U.S. Pat. No. 4,239,377 issued Dec. 16, 1980 is hereby incorporated by reference in its entirety. A punch marker 90 is diagrammatically illustrated in FIG. 6. As to providing thermal markings, such as a nine element straight line dot matrix in which selective activation of the elements form the desired character or code, the Pearce et al. U.S. Pat. No. 4,629,312 issued Dec. 16, 1986 is hereby incorporated by reference in its entirety. A thermal marker 92 is diagrammatically illustrated in FIG. 6.

Marker 94 is an optical (or laser based with LED print heads) marker and marker 95 is a backwriter marker where information such as copyright ownership information (i.e. usually the studio name and address) is printed.

Preferably, the LCD chip 52 is used to its maximum extent for the image itself. In other words, information associated with the image is preferably excluded from the LCD chip 52 and is instead delivered to one or more of the markers 90, 92, 94 and 95, preferably the optical marker 94. By maximizing the size of the image on the LCD chip, the resolution of the image is maximized. Such a resolution, it should be noted, is not lost as the image is manipulated by one or more lenses in the lens cluster 30. Further, by excluding non-image information from the LCD chip generated image, speed of the high-speed photographic printing process is maximized; it simply takes time to deliver such non-image information, such as text information, to the LCID chip 1052.

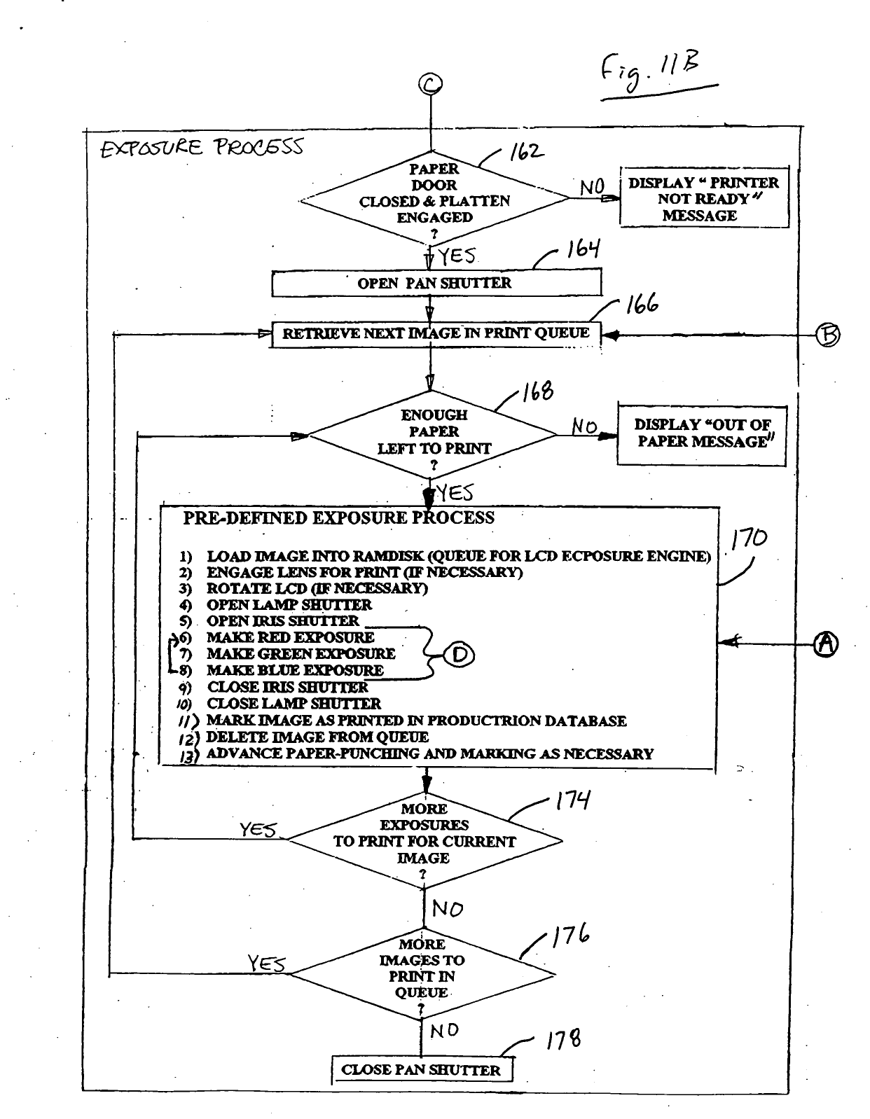

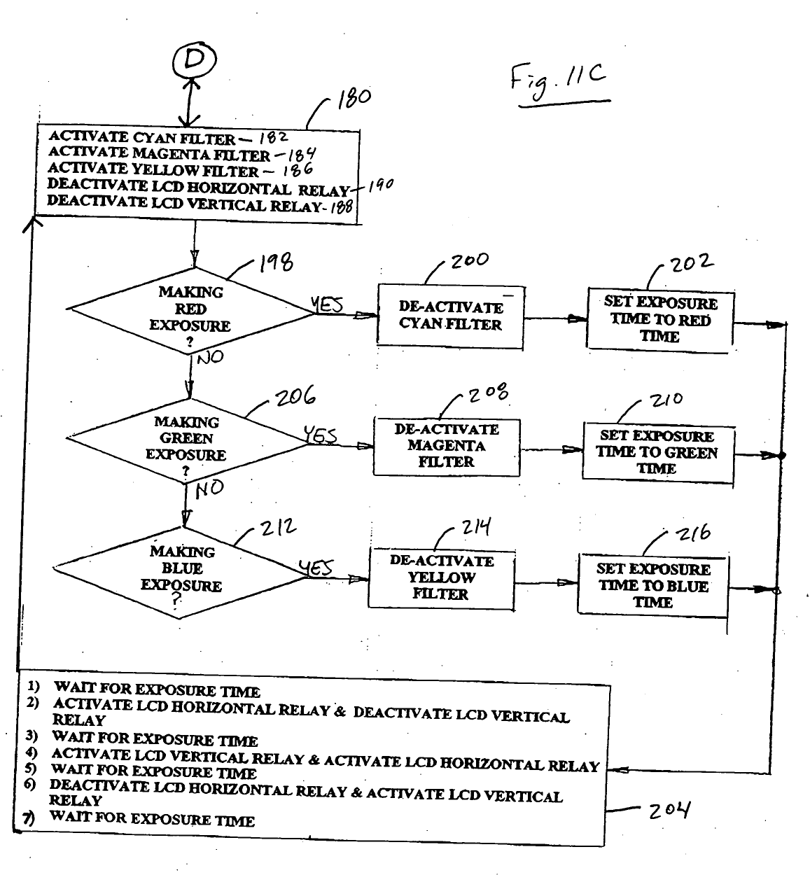

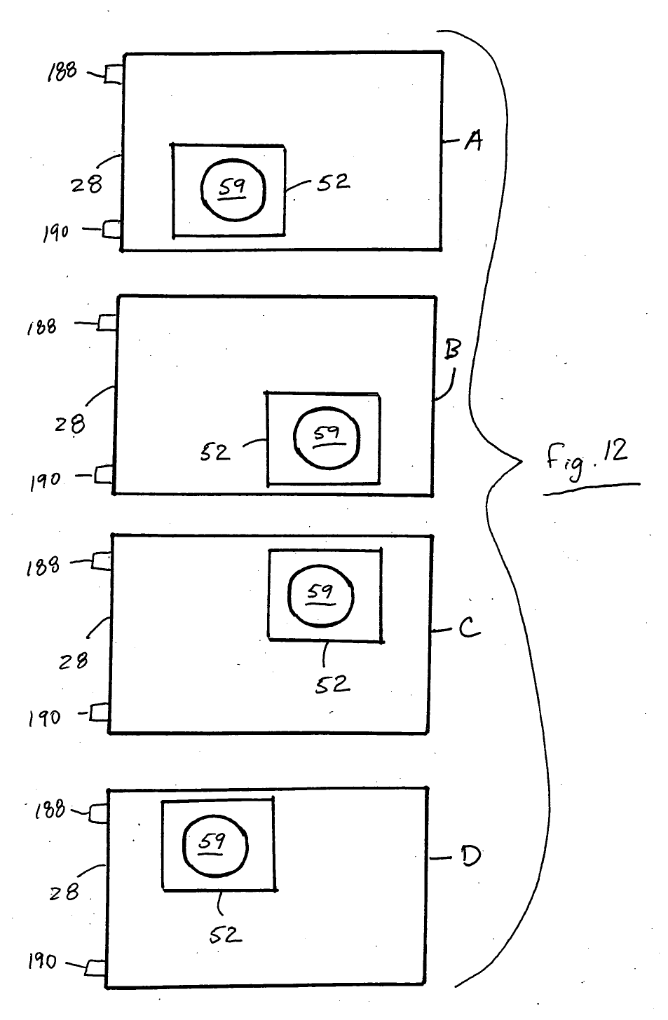

The optical marker 94 allows an operator to print user definable text and barcodes between units (panels, images or packages). Such printed information is delivered from a control file, such as station 154 shown in FIG. 11A, that describes the digital file from a user definable field. The optical marker 94 can also print a new optical cut mark that can be read by conventional high-speed print cutters. An important feature of the optical marker 94 is that a text field no longer needs to be rendered into a file itself. This means faster rendering times and the individual files can be passed to the printer 22 for imaging without having to first render a cut code or ID code into the file.

As to developing photosensitive paper 86 after exposure at the processing station 14, the Lucht et al. U.S. Pat. No. 4,931,826 issued Jun. 5, 1990 entitled, “Photographic Printer-Processor,” is hereby incorporated by reference in its entirety.

An inspection station 16 may simply be a table or work surface manned by an individual who looks at each of the developed images to ascertain whether problems exist either with the printing station 12 or processing station 14. The inspection station 15 may include an apparatus that drives the developed photosensitive paper roll at variable speeds with forward and reverse modes. It may further include a viewing area such that an entire order or package may be seen as a whole at one time. The inspection apparatus may include guides that control the paper without tearing the developed roll of paper.

Prior to the cutting station 18, the photosensitive paper 86 in the present high-speed photographic printing process is in the form of a roll having exposed or developed images. At the cutting station 18, the roll is cut by a cutter, making lateral and/or longitudinal and/or other angled cuts in the roll such that individual packages containing one or more images may be obtained. In other words, the cutter separates orders from each other, and also separates images or sets of images within each of the orders. As to one such cutter, the Bartz U.S. Pat. No. 4,506,824 issued Mar. 26, 1985 and entitled, “Paper Cutter,” is hereby incorporated by reference in its entirety.

The cutting station 18 ascertains where the cuts are made by reading, scanning marked, punched or otherwise engaged information adjacent to the images. Such marked information may be provided by one or more markers 25 90, 92, 94 and 95. Such marked information may inform the cutting station 18 where it is in the operating system that the information about making the cuts may be accessed. Such marked, punched or other information is decoded by the sensor or reader at the cutting station so as to identify print sizes and placement on the paper. The cutting station then automatically cuts and trims images from the size of sub-wallet images to eleven by fourteen inch images. The cutter of the cutting station 18 may also be programmed to cut paper into custom sizes.

The cutting station 18 may trim the developed photosensitive material as well as cut it. The cuts are made in the roll of photosensitive paper in order to both separate orders from each other, and to separate images or sets of images within each of the orders. Each of the orders is preferably packaged both automatically and separately from each of the other orders.

A high-speed photographic printer is a printer that, for the purposes herein, exposes a certain amount of unique 8 inch by 10 inch images (or their equivalent) per hour on the photosensitive paper 86. This amount is preferably between about 300 and about 2000 and exposes between about 1000 and 2000 images per hour in a preferred embodiment. Generally, an exposure cycle (one iris exposure) three color exposures and twelve positional exposures may take about four seconds for a unique eight inch by ten inch panel and about 720 eight inch by ten inch panels per hour.

FIGS. 11A, 11B, and 11C show a printing process for the high-speed photographic printer 22. As shown in FIG. 11A, a first step includes the reception and subsequent editing of digital image information at an image editing station 150, such as at processor 34 with keyboard 152, with software such as Adobe Photoshop or Kodak DP2. One sub-step at the image editing station 150 is keying in information, such as customer order information. For example, if photo information from an elementary school is received, the student's names will be keyed in. This keyed in information is then outputted to a control file 154. Raw image data, such as contained in a Windows® bit map file, tiff file, or jpg file, is rendered to a print queue 156. A verification station 158 compares the order data or order information to resources currently available on the specific high-speed photographic printer 22 and further compares the raw image data 156 to resources currently available on the specific high-speed photographic printer 22. One such resource is paper or a certain type of paper. Another such resource is a lens or a particular duster of lenses. After verification, the order data is loaded into a production database 160.

FIG. 11B shows another portion of the process continued from FIG. 11A. Initiation of step 162 is controlled by the verification step 158. When initiated, step 162 inquires whether the door to the light sealed 20 cabinet 32 is closed and whether the platten 87 is engaged. If not, then the monitor 36 displays the message “printer not ready.” If the system confirms that the door to the light sealed cabinet 32 is closed and the platten 87 is engaged, then the system proceeds to open the pan shutter 84 via step 164. After receiving confirmation that the pan shutter 164 has been opened, the system proceeds to step 166, which is the retrieval of an image (or the subsequent image) from print queue 156. After receiving confirmation that the image has been retrieved, the system inquires with step 168 whether sufficient photosensitive paper 86 is available. If not, then the monitor 34 displays the message “out of paper.” If the system responds affirmatively, the predefined exposure process step 170 is initiated.

Step one of the predefined exposure process may include the following: in the predefined exposure process step 170, the image data is loaded into a “ramdisk.” The “ramdisk” is in fact not a disk, although the system may perceive the “ramdisk” as a disk. The “ramdisk” is RAM (random access memory). A disadvantage of RAM, relative to hard drive storage, is that it is volatile; when power is cut off, the information stored on the RAM is lost. An advantage of RAM, relative to hard drive storage, is that information may be loaded onto and retrieved from RAM relatively quickly. Another advantage of RAM, relative to hard drive storage, is that the integrity of the data remains at a relatively high level. With hard drive storage, information may become fragmented. RAM hardware may be engaged in the processing of unit 34 or in the control panel 38.

Step two of the predefined exposure process may include the following: once the image is loaded onto the “ramdisk,” the system, via plungers or other apparatuses, drives one or more lens drawers of lens cluster 30 into position, such that the lens or several lenses of the lens cluster are then aligned with optical axis 64 or with like optical axis. In this way, the optical image is split so as to print two or more images from one image formed on the LCD array 52.

Step three of the predefined exposure process may include the following: after the predefined lens or several lenses are engaged, the LCD device 28 may be rotated to make the best use of the fixed resolution of the LCD array 52 relative to the customer order (how many prints and the size of the prints). The LCD device 28 may also be rotated to make best use of the space available on the photosensitive paper 86. If the LCD array 52 is rectangular, then the LCD array 52 may be rotated ninety degrees.

Step four of the predefined exposure process may include the following: after the step of rotating the LCD array 52 or the step of determining the orientation of the LCD array 52 relative to the lens cluster 30 or the photosensitive paper 86, a lamp shutter 172 is opened. One type of lamp shutter 172 is shown in FIG. 14 where the lamp shutter 172 pivots about the light source 35. Lamp shutter 172 may have a pinhole aligned with the optical axis 64. The phantom lines indicate a closed position for the lamp shutter 172. Alternatively, the lamp shutter or dark filter may be disposed at another location below the mirrored mixing chamber 39.

Step six of the predefined exposure process may include the following: after the lamp shutter 172 is opened, the system opens the iris shutter 82 or several iris shutters 82 that may be engaged in a drawer which can slide in and out of the optical axis 64 or split optical axis.

Steps six, seven and eight of the predefined exposure process may include the following: after the iris shutter or shutters 82 are opened, the red exposure is made, then the green exposure is made and then the blue exposure is made. These steps are defined in greater detail below in reference to FIG. 11C. To make one image on the photosensitive paper 86, the high-speed photographic printer may make one, three or twelve exposures from a definitional standpoint. From the perspective of the iris shutter 82, theme is only one exposure. From the standpoint of the colored filter that is dialed in, there are three exposures, one for each of the red, green and blue exposures. From the standpoint of the LCD array 52, there are twelve positional exposures; there are four positional exposures for red, four positional exposures for green and four positional exposures for blue. FIG. 12 shows four positional exposures to rid the ultimate image of dead spaces formed between pixels of the LCD array 52.

Step nine of the predefined exposure process may include the following: after the twelve positional exposures have been made, the iris shutter or shutters 82 are closed.

Step ten of the predefined exposure process may include the following: after the iris shutter or shutters 82 are closed, the lamp shutter 172 is closed, as shown in FIG. 14.

Step eleven of the predefined exposure process may include the following: the image is marked as printed in the production database 160.

Step twelve of the predefined exposure process may include the following: the system deletes the image information from the print queue 156.

Step thirteen of the predefined exposure process may include the following: the photosensitive paper 86 is then marked with one or more of the markers 90, 92, 94, 95 on one or more of the front and back sides of the photosensitive paper, where the front side of the photosensitive paper is defined as the photosensitive side. The marking may be human readable or machine readable. If the marking is on the front side, the marking may be adjacent to the exposed image. If the marking is on the back side, such as copyright information or information about the studio, the marking is preferably directly opposite some portion of the image. This marked information, whether on the front side or back side, may then be read by a scanner or an individual if it is human readable. This reading may occur at one or more of the processing stations 14, the inspection station 16, the cutting station 18 and/or the packaging station 20. As to the position of the photosensitive paper 86 during marking operations, the photosensitive paper may be at the position where it was exposed or it may be advanced from the position where it was exposed. This step completes the predefined exposure process step 170.

After the predefined exposure process step 170, the system via step 174 queries whether the customer order includes a request for more exposures from the current image rendered by the LCD array 52. If the system answers affirmatively, then the system returns to step 168. If the customer order requires no more exposures, then the system proceeds to step 176 and inquires whether there are more images to print in the print queue 156. If yes, then the system returns to step 166. If no, then the system closes the pan shutter 84 via step 178.

FIG. 11C and FIG. 12 show the twelve positional exposures. Generally, the exposure process includes three separate exposures: red, green and blue. The LCD chip 52 is a black and white image that projects individual red, green and blue densities of the file. When the red density is in place, the filters move into position for the red time. This process repeats for the green density and blue densities of the file. During each positional exposure, the image is moved one pixel in each direction.

Step 180 of FIG. 11C follows the fifth sub-step (opening the iris shutter 82) of the predefined exposure process step 170. As shown in FIG. 14, in step 180, the cyan filter 182, the magenta filter 184 and the yellow filter 186, are activated. When all such filters 182, 184 and 186 are activated, little or no light passes to the LCD array 52. Also during step 180, as shown in FIG. 12, the system deactivates an LCD vertical relay 188 and an LCD horizontal relay 190. Such an activation slides the LCD array 52 and the corrective lens arrangement 59 as one unit, horizontally or vertically relative to the LCD device 28. As shown in FIG. 14, filters 180, 182, 184 are dialed-in filters which are in contrast to a fixed cyan filter 192, a fixed magenta filter 194 and a fixed yellow filter 196. After the filters 182, 184, and 186 are activated and the relays 188 and 190 are deactivated, the system inquires via step 198 whether a red exposure is to be made. If so, then the system deactivates the cyan filter 182 via step 200. Then via step 202, the system sets a red color exposure time to a predefined amount of time.

The system then proceeds to step 204 whereupon the system waits for a predefined amount of time with the relays 188 and 190 deactivated. This position diagrammatically illustrated in exaggerated fashion by letter A in FIG. 12. This is one positional exposure which is the first sub-step of step 204. In the second sub-step of step 204, the LCD horizontal relay 190 is activated and the LCD vertical relay 188 is deactivated (or remains deactivated). As shown in FIG. 12, the LCD array 52 moves and the corrective lens arrangement as a whole, is moved a minute amount, such as one micron, to a position H.

In the third sub-step of step 204, the system waits for a predefined amount of positional exposure time with the LCD array 52 and corrective lens arrangement 59 being in the position B shown in FIG. 12.

In the fourth sub-step of step 204, the LCD vertical relay 188 is activated and the LCD horizontal relay is activated (or remains activated), sliding the LCD array 52 and corrective lens arrangement, as a whole, a minute amount, such as one micron to a position C. In the fifth sub-step of step 204, the system waits for a predefined amount of positional exposure time with the LCD array 52 and corrective lens arrangement 59 being in the position C. In the sixth sub-step of step 204, the LCD horizontal relay 190 is deactivated and the LCD vertical relay 168 is activated (or remains activated). This slides the LCD array 52 and corrective lens arrangement, as a whole, a minute amount, such as one micron, to a position D.

In the seventh sub-step of step 204, the system waits for a predefined amount of positional exposure time with the LC D array 52 and corrective lens arrangement 59 in the position D shown in FIG. 12. This seventh step completes step 204 for step 198, the step of making the red exposure t should be noted that the color exposure time is equal to or substantially equal to the sum of the four positional exposure times designated by letters A, B, C and D in FIG. 12.

The system then returns to step 180 (whereupon the relays 188 and 190 are deactivated such that the LCD array 52 and corrective lens arrangement slide to the “original” position shown by letter A in FIG. 12 and subsequently to step 206, the step of making a green exposure. Then, the system moves to step 208 which is de-activating the magenta filter 184. Subsequently is step 210 of setting the green color exposure time. Next is step 204 and its seven sub-steps.

The system then returns to step 18 whereupon the relays 188 and 190 are deactivated such that the LCD array 52 and corrective lens arrangement slide to the “original” position shown by letter A in FIG. 12. Subsequently, the system goes to step 212 of making a blue exposure. Then, it moves to step 214 deactivating the yellow filter 186. Next is step 216 where the blue color exposure time is set and then, the system moves to step 204 and its seven sub-steps.

Upon completion of all three color exposures (twelve positional exposures), the system proceeds next to sub-step nine of step 170 of closing the iris shutter 82. It should be noted that one iris shutter exposure is the equivalent of three color exposures which is the equivalent of twelve positional exposures. The corrective lens arrangement 59 may remain at rest relative to LCD device 28 and that only the LCD array 52 may be slid or actuated by the vertical relay 188 and the horizontal relay 190. During the shifting of the LCD chip 52, and shutters are closed. The filters are activated for the appropriate color beforehand.

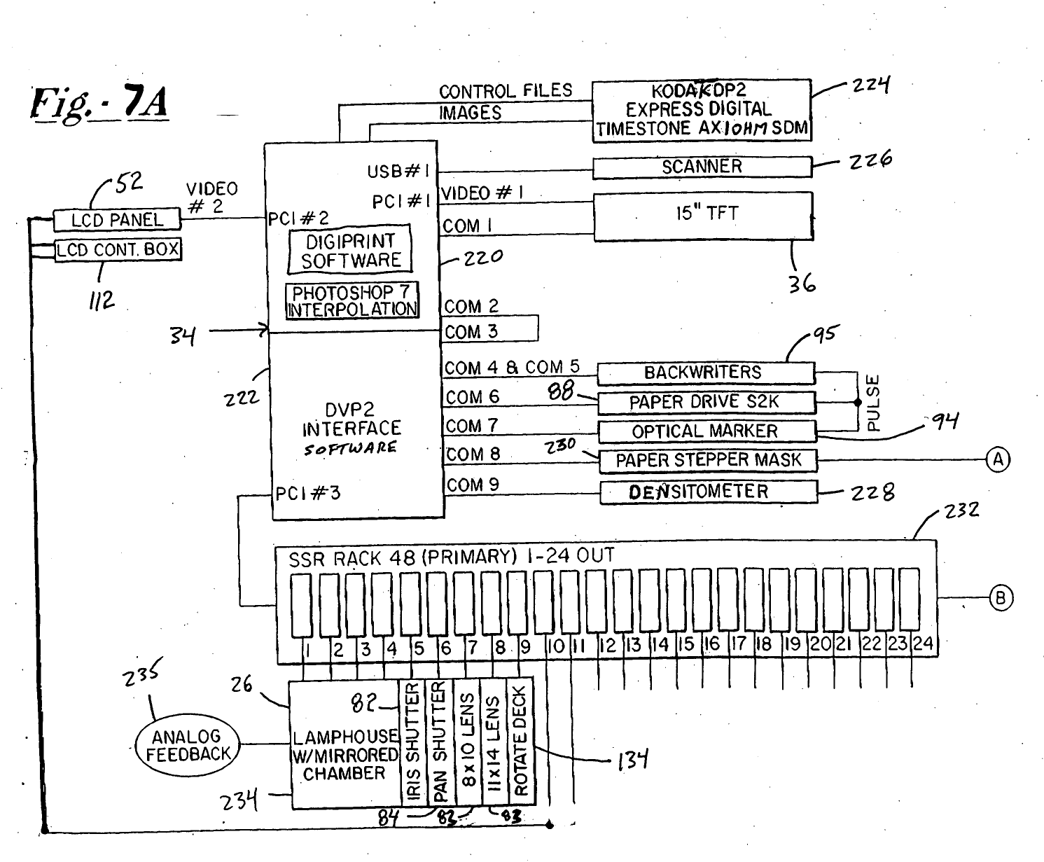

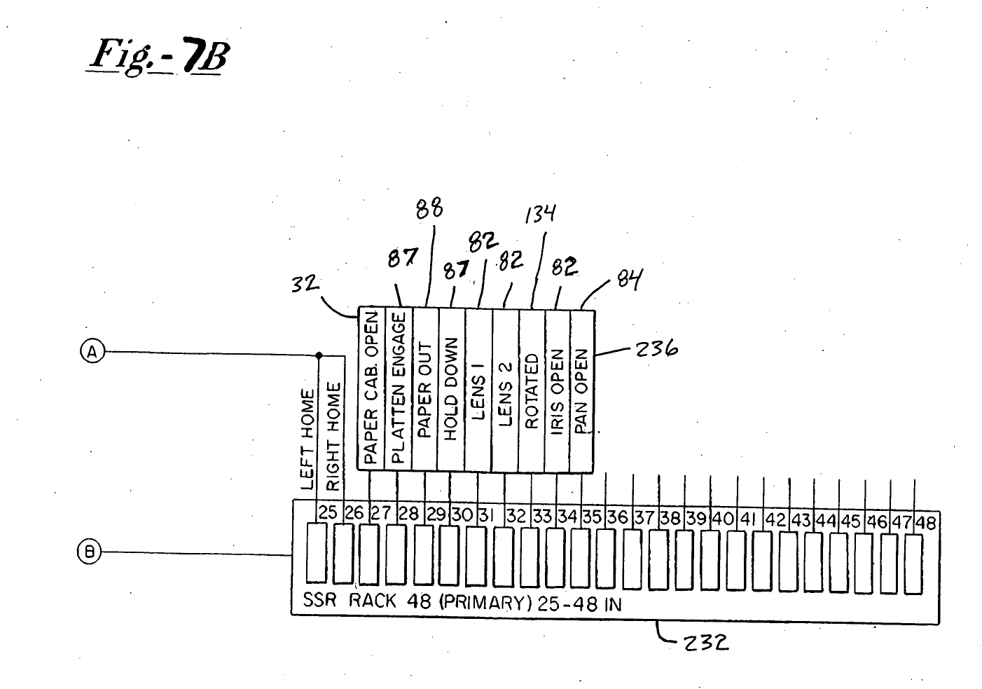

As shown in FIG. 7A, a first software package or first set of instructions 220 communicates with a second software package or second set of instructions 222 via corn ports 2 and 3. The first set of instructions 220 communicates with one of more conventional or “off-the-shelf” third software packages 224 such as Kodak Digital 15 Photo 2 (Kodak DF2) available from any of the following: Eastman Kodak Company of Rochester, N.Y.; Express Digital available from Express Digital Photo of San Diego, Calif.; Timestone software available from Timestone Software of Bentleigh East, Australia: Axiohm software which may include a set of instructions for marking the photosensitive paper available from Axiohm Transaction. Solutions, Inc. of Ithaca, N.Y.; or SDM software available from Imager Service Associates, Bloomington, Minn. The first set of instructions may include a fourth software package entitled Digiprint Software available from Muellersohn Potalabor Technik GmbH of Bielefeld, Germany. A fifth software package entitled Photoshop 7 including an interpolation set of instructions is available from Adobe Systems Incorporated of San Jose, Calif. As shown in FIG. 7A, some of the information that may be received by the first set of instructions 220 from the third set of instructions 224 include control file information such as customer order information and raw image data.

The first set of instructions 220 may also communicate with a scanner 226 for directly entering raw image data onto a hard drive in the processor 34 or into the “ramdisk” or RAM (in the processor 34 or control cabinet 38). The scanner 226 may also be utilized in combination with the densitometer 228, where a developed image is scanned and is calibrated by the densitometer for gray or other color information, the results of which are analyzed and used for manipulating color characteristics of the light impinging on the LCD array. This scanned image may also be analyzed for defects other than color defects.

The first set of instructions 220 also communicates with the monitor 36. The monitor 3 is preferably a “touch screen” monitor 36 such that keyboard 152 may not be required. The first set of instructions 220 further communicates with the LCD device 28 including the LCD array 52, such as providing video information to the LCD panel 52.

The second set of instructions 222 communicates with dual quadrant backwriter 95, the optical marker 94 and the paper drive control mechanism 88. Optical marker 94 is a laser based printer and encodes the front side (the photosensitive side) of the photosensitive paper 86 with information. This information is either human-readable or, readable by a scanner or other reader at processing station 14, inspection station 16, cutting station 18 and packaging station 20. The backwriter 95 imprints the back side (the non-photosensitive side) of the photosensitive paper 86 with information such as copyright ownership information.

The second set of instructions 222 further communicates with a paper stepper mask 230 engaged in the light sealed cabinet 32. The paper stepper mask 230 is a mask having one or more mask portions, preferably two mask portions that are disposed between the photosensitive paper 85 and the light source 35. Masking portions are movable across (horizontally) and confront the photosensitive side of the photosensitive paper 86. Mask portions mask or cover sections of the photosensitive paper 86 to which light is not to be exposed. Mask portions effectively “crop” the image that is being exposed. Mask portions, when confronting the photosensitive side, may extend longitudinally across the photosensitive side and/or may extend laterally across the photosensitive side. Electronic rack 232 includes switches for driving one or more mask portions to a home position, such as to a left or right designated home position. This home may be designated as a position inside or outside the area of light exposure by light source 35.

The second set of instructions 222 further communicates, via electronic rack 232, with one or more of the following: the lamphouse 26, mirrored mixing chamber 39, and iris shutter 82, pan shutter 84, one or more of the lenses 83. This communication results in making eight inch by ten inch exposures and/or eleven inch by fourteen inch exposures. It could also result in creating a rotary table or deck 134, a door of the light sealed cabinet 32, a platten 87, a paper drive mechanism 88, an LCD control box 112, an LCD panel 52, and/or a paper stepper mask 230.

Block 234 of FIG. 7A shows that the second set of instructions, via electronic rack 222, may control operation of: the lamphouse 26, mirrored mixing chamber 39, iris shutter 82, pan shutter 84, an eight inch by ten inch lens 83, an eleven inch by fourteen inch lens 83, and rotary table 134. Reference number 235 indicates that the second set of instructions 222 may receive information in the form of analog feedback from sources such as a voltage regulator or heat sensor in the lamphouse 26.

Block 236 of FIG. 7B shows the second set of instructions which occur via electronic rack 22 in the following sequence: the instructions may inform the operator of the system that a door of the light sealed cabinet 32 is open (see step 162); next the instructions may inquire whether the platten 87 is engaged (see step 162); then it may inquire whether sufficient photosensitive paper 86 is sufficient to print (see step 168); hence it may inquire whether the photosensitive paper 86 is being held down by the vacuum platten 87; next it may inquire whether one or more lenses drawers are engaged with the optical axis 64; it may then rotate the rotary table 134; and then it may open the iris shutter 82, and it may open the pan shutter 84.

Conventional photosensitive paper and conventional film negatives have orange hue characteristics. An image shot onto photosensitive paper via an LCD without compensating for orange hue characteristics will not have the conventional or professional appearance, or the “look and feel” of a professional photograph.

Orange hue compensation may be accomplished in at least one of two ways. One approach is to insert an orange transparency or orange colored plastic sheet or glass 240 between diffuser 42 and the LCD device 28. The orange transparency 240 is preferably placed as close to the LC D array 52 as possible. If desired, the orange transparency 240 may be placed between the LCD device 28 and the lens cluster 30. Another approach is to apply a coating to any cold mirror in the system, such as cold mirror 172, such that light reflected from the cold mirror has an orange hue characteristic.

It should further be noted that the orange hue may be selected from certain degrees of orange hue. Different manufacturers provide different orange hues to their photosensitive paper, and the degree of orange hue selected by the present invention may be associated with the degree of orange hue provided by a certain manufacturer. For example, one orange transparent sheet 240 may have a certain degree of orange hue and may be slid out of place; whereas a second orange transparent sheet 240 having a different shade of orange may be slid into place across the optical axis 64.

It should be noted that the desired orange hue is different from any orange color provided by the fixed cyan, magenta, or yellow filters that are dialed in during a set-up procedure. It should be noted that the orange transparent sheet 240 is present in the optical axis 64 when the red exposure is made and the cyan filter is deactivated (step 200). The orange transparent sheet 240 is also present in the optical axis 64 when the green exposure is made and the magenta filter is deactivated (step 208), and is further present in the optical axis 64 when the blue exposure is made and the yellow filter is deactivated (step 214).

Photosensitive material includes photosensitive paper or paper having photosensitive portions such as Christmas cards, greeting cards, identification (ID) Cards etc. An image includes a graphic or photograph or text or other indicia.

1. A high-speed photographic printer for printing images on photosensitive material, comprising:
a) a light source;
b) a light sealable housing in which the photosensitive material is engaged; and
c) an imaging active matrix liquid crystal display for producing an image through which light passes for printing said image onto the photosensitive material, wherein the imaging active matrix liquid crystal display is disposed between the light source and the light sealable housing which has the photosensitive material.

2. The high-speed photographic printer according to claim 1, and further comprising a corrective lens confronting the imaging active matrix liquid crystal display.

3. The high-speed photographic printer according to claim 1, wherein the corrective lens and imaging active matrix liquid crystal display are actuable as a unit, wherein said unit can be actuated a sufficient distance to compensate and rid an exposed image of pixel dead space.

4. The high-speed photographic printer according to claim 1, and further comprising another corrective lens, wherein each of the corrective lenses is aligned along an optical axis with the other corrective lens, and wherein one of the lenses is a convex lens and one of the other lenses is a diffusing lens.

5. The high-speed photographic printer according to claim 1, consists of a lens drawer disposed between the imaging active matrix liquid crystal display and the light sealable housing, wherein the lens drawer includes a first lens disposed at a first focus height relative to the imaging active matrix liquid crystal display and a second lens disposed at a second focus height relative to the imaging active matrix liquid crystal display. The first and second lenses are movable in and out of alignment, within said lens drawer, with an optical axis of the imaging active matrix liquid crystal display, and wherein said first and second lenses are enlarging lenses.

6. The high-speed photographic printer according to claim 1, consists of a lens drawer disposed between the imaging active matrix liquid crystal display and the light sealable housing, wherein the lens drawer includes first and second lenses disposed at a first focus height relative to the imaging active matrix liquid crystal display, wherein the first and second lenses are movable in and out of alignment, within said lens drawer, with an optical axis of the imaging active matrix liquid crystal display, and wherein said first and second lenses are enlarging lenses.

7. The high-speed photographic printer according to claim 1 further comprising a random access memory large capacity solid state device for storing image information for the imaging active matrix liquid crystal display.

8. The high-speed photographic printer according to claim 7 further comprises a set of instructions and an operating system for the high-speed photographic printer, wherein, the set of instructions includes a perception instruction to permit the operating system to perceive said random access memory large capacity solid state device as a hard drive.

9. The high-speed photographic printer according to claim 1 further comprises a laser based optical marker in the light sealable cabinet for marking the photosensitive material on or adjacent to the image with information to be utilized down line from the high-speed photographic printer.

10. The high-speed photographic printer according to claim 1, and further comprises a managed light stream emanating from the light source, wherein the managed light stream is managed by cyan, magenta and yellow color filters, and where the managed light stream further includes an orange hue.

11. The high-speed photographic printer according to claim 10, wherein the orange hue is provided by an orange 20 transparency movable in and out of the light stream.

12. The high-speed photographic printer according to claim 10, wherein the orange hue is provided by a cold mirror.

13. The high-speed photographic printer according to claim 10, wherein, said orange hue includes a certain shade of orange which in turn is associated with a certain shade of orange of said photosensitive material.

14. The high-speed photographic printer according to claim 1, and further comprising a paper control mechanism in the light sealable housing for advancing the photosensitive material in and out of an optical axis, wherein the imaging active matrix liquid crystal display and paper control mechanism can expose and advance, respectively, between about 300 and about 2000 unique eight inch by ten inch images, or their equivalent, per hour.

15. A method for printing onto photosensitive material using an imaging active matrix liquid crystal display, comprising the steps of: a) directing light through the imaging active matrix liquid crystal display to pick up an image; then b) directing the light through a lens cluster spaced from the imaging active matrix liquid crystal display; and then directing the light onto the photosensitive material.

16. The method of claim 15 further comprises as step which is between the steps of directing the light through the imaging active matrix liquid crystal display and directing the light through the lens cluster. This is the step of directing the light that has the image through a corrective lens arrangement confronting the imaging active matrix liquid crystal display.

17. The method of claim 15 further comprises, prior to the step of directing the light through the imaging active matrix liquid crystal display, the step of loading information quickly to the imaging active matrix liquid crystal display from a random access memory large capacity solid state device.

18. The method of claim 15 further comprises the steps of: a) optically marking the photosensitive material with information associated with the image and then b) reading said information and c) cutting the photosensitive material in response to the step of reading said information.

19. The method of claim 15 further comprises the steps of: a) making a unique eight inch by ten inch image from repeating the step of directing light through the imaging active matrix liquid crystal display; and by repeating the step of making a unique eight inch by ten inch image from about 300 times to about 2000 times per hour.

20. A method for printing onto photosensitive material using an imaging active matrix liquid crystal display, comprising the steps of:
a) loading image information into a random access memory large capacity solid state device; and
b) unloading said image information from the random access memory large capacity solid state device to the imaging active matrix liquid crystal display.
